(19) United States
(12) Patent Application Publication
(10) Pub. No.: US 2007/0160823 A1
(43) Pub. Date: Jul. 12, 2007

(54) Three dimensional structures and method of making the structures using electronic drawing data

(76) Inventors: Matthew R. Pyzik, Howell, MI (US); John P. Pacella, Rochester Hills, MI (US); Terry J. Hopkins, Southfield, MI (US)

Correspondence Address: HARNESS, DICKEY & PIERCE, P.L.C., P.O. BOX 828, BLOOMFIELD HILLS, MI, 48303, US

(21) Appl. No.: 11/328,770

(22) Filed: Jan. 10, 2006

(51) Int. Cl. B32B 3/26; B29C 33/40; B29C 41/20

(52) U.S. Cl. 428/304.4; 264/219; 264/259; 264/279; 264/279.1; 264/162

(57) ABSTRACT

A three dimensional structure having finished surfaces defined by electronic data includes a core of expanded polypropylene foam having at least one surface offset from one of the finished surfaces of the three dimensional structure and a layer of hardened paste bonded to the offset surface of the core of expanded polypropylene foam. The hardened paste is machined to define the finished surfaces of the three dimensional structure.

### BACKGROUND OF THE INVENTION

This disclosure generally relates to light weight, low cost three dimensional structures constructed using electronic surface data. More particularly, composite three dimensional structures constructed using expanded polypropylene foam are disclosed.

Automotive vehicle design is a very complicated process. A proper design assures that numerous components may be assembled to one another to provide a functional and aesthetically pleasing vehicle to the customer. Much of vehicle component design includes the use of computer aided design (CAD) software to define the geometry of the components. The software assists designers electronically define relatively complex interior and exterior surfaces that are exposed to the eye of the consumer. While the computer aided design programs have allowed visualization of vehicle component surfaces through the use of computer graphics, it was been found that a full scale three-dimensional model must be created to verify the design.

A full scale design verification model allows designers, executives and would-be customers to get a better “feel” for a design by physically walking around the model and/or sitting in the passenger compartment of the model. Furthermore, construction of a design verification model focuses attention on the interconnection of various components and clearances required between components such as vehicle doors and door jams.

Previous design verification models have been created in an attempt to achieve the goals previously described. One such model includes a steel armature sized and shaped to support a number of planks or blocks. The blocks are bolted to the steel armature which typically includes castors to allow the assembly to be rolled along a floor. The planks or blocks are bonded to one another in the rough shape of the model.

The planks or blocks are constructed from a very rigid and dense two-part epoxy material typically called “wren board.” The wren board structure is machined to define the exterior surfaces to be modeled. Because the two-part epoxy material is very dense, the blocks are very heavy. Accordingly, the steel armature must be constructed from material having sufficient strength to support the heavy blocks. As such, the armature is also very heavy. The weight of the assembly oftentimes requires the use of a forklift or a crane to move the model. Special shipping concerns also exist relating to the extreme weight of the assembly. The wren board is also very costly.

Additionally, it is sometimes necessary to redesign or modify a relatively small portion of the design verification model to account for style changes and/or modifications necessary to properly coordinate with an adjoining part. To modify a portion of the two-part epoxy model, an insert must be created from a separate plank or block. A recess must be machined into the previous model to accept the new insert. This process is time consuming. It is also relatively difficult to properly match the insert to the existing design verification model. Alternatively, a material other than the original two-part epoxy may be used to create the modified portion. Unfortunately, the repair will be visually obvious to one viewing the model. This may draw undue attention to certain areas of the model.

Furthermore, the two-part epoxy plank or block material typically used to create design verification models is not recyclable and creates a further cost and complication relating to disposal of these materials at the end of their service life.

It should be appreciated that the CAD models previously described are also useful for constructing the tooling used to create the parts defined by the CAD data. Before a commitment of many thousands or possibly millions of dollars is made to construct production level tooling, it is common practice to first construct prototype components for evaluation. At this stage of product development, modifications to the component design are relatively inexpensive. Much more time and money may be wasted if changes have to be made to production level tooling.

Many methods for constructing prototype parts exist. Some of these methods include creating parts from drawings and not the CAD data that will be used to construct the production level tools. As such, the prototype part constructed from this type of tool may not represent a component made from with a tool constructed from CAD data. Other methods include constructing “one-off” molds that are only able to produce one component part because the mold is destroyed during the prototype production process. Still other methods include creating low volume prototype molds using the two-part epoxy previously mentioned. The molds created with the two-part epoxy are very heavy and very costly. Accordingly, these molds are also difficult to move due to their weight. Molds constructed from two-part epoxy are also difficult to modify. Lastly, the two-part epoxy is relatively hard and requires relatively slow machining to produce an accurate surface having a suitable surface finish. Accordingly, a need in the art exists for low cost, low weight three dimensional structures constructed using computer generated surface data.

### SUMMARY OF THE INVENTION

The disclosure presents a three dimensional structure having finished surfaces defined by electronic data. The three dimensional structure includes a core of expanded polypropylene foam having at least one surface offset from one of the finished surfaces of the three dimensional structure and a layer of hardened paste bonded to the offset surface of the core of expanded polypropylene foam. The hardened paste is machined to define the finished surfaces of the three dimensional structure. A method of making such a three dimensional structure is also disclosed.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial perspective view of a design verification model constructed in accordance with the disclosure;

FIG. 2 is a fragmentary cross-sectional view taken along line 2-2 as shown in FIG. 1;

FIG. 3 is a fragmentary cross-sectional view depicting an alternate embodiment panel including a fastener extending through the panel;

FIG. 4 is a cross-sectional side view of a core constructed from expanded polypropylene foam;

FIG. 5 is a cross-sectional side view of a work-in-process level foam core coated with a modeling paste;

FIG. 6 is a cross-sectional side view of a finished design verification model panel;

FIG. 7 is a perspective view of a mold constructed in accordance with the teachings of the present disclosure;

FIG. 8 is a cross-sectional view taken along line 8-8 shown in FIG. 7;

FIG. 9 is a cross-sectional view of a mold body;

FIG. 10 is a cross-sectional view of a work-in-process mold having a foam body and a layer of modeling paste; and

FIG. 11 is a cross-sectional view of a finished mold.

### DETAILED DESCRIPTION

The following description is merely exemplary in nature and is not intended to limit the present disclosure, application, or uses. It should be understood that throughout the drawings, corresponding reference numerals indicate like or corresponding parts and features.

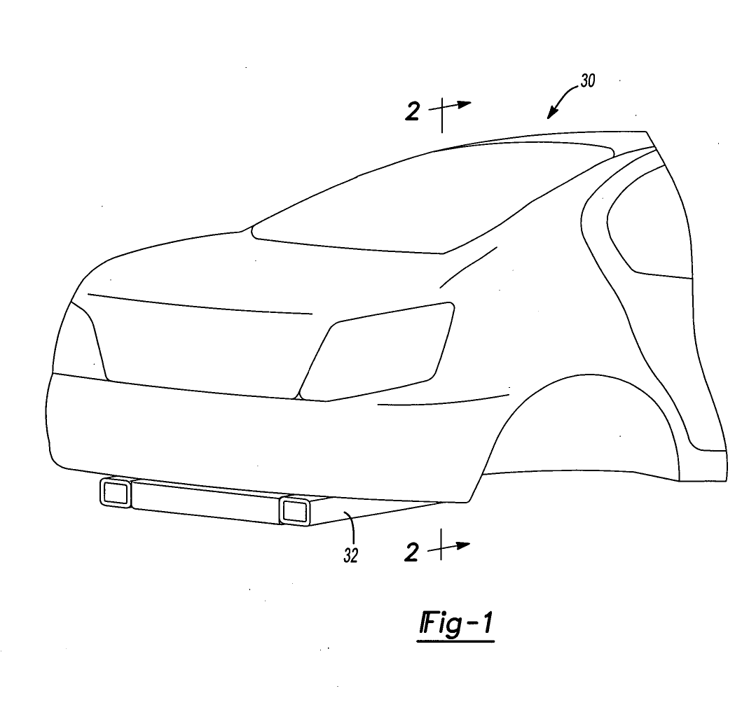

FIGS. 1-11 depict various examples of three dimensional structures created using computer generated data. Each of these structures is configured as a composite having a base or a core formed from expanded polypropylene foam. The core is partially or completely coated with a layer of hardenable modeling paste. A sufficient amount of modeling paste is applied to the core to provide machining stock. The paste is hardened and machined to provide a finished surface having the dimensional characteristics of the electronic data.

FIGS. 1-6 depict a design verification model 30 having a steel armature 32 and a number of composite panels interconnected to one another to define the internal and external surfaces of the design verification model 30. By constructing design verification model 30 in this manner, external vehicle surfaces as well as internal vehicle surfaces facing the passenger compartment or the trunk compartment may also be verified with a single model.

A side panel 36 includes an exterior surface 38 and an interior surface 40. Exterior surface 38 and interior surface 40 are machined surfaces that have been defined by the CAD data that require verification. Side panel 36 includes a core 42 constructed from expanded polypropylene foam. A shell 44 surrounds core 42. Shell 44 is constructed from a modeling paste such as provided by Axson under product names such as SC261, SC300 and SC167. Suppliers such as Huntsman and Sanyo Chemical also commercially provide modeling paste.

Modeling paste is sufficiently dense to allow a finished machining process to provide an aesthetically pleasing surface finish. Additionally, the modeling paste is not as dense as the two-part epoxy previously described. Accordingly, three dimensional structures constructed using the modeling paste are much more easily machined than the prior art structures. Therefore, the time required to machine the finished surfaces is substantially less than the time previously required.

An aperture 46 extends through core 42. Aperture 46 is filled with a column 48 of modeling paste to provide additional structure to side panel 36. It should appreciated that any number of columns similar to column 48 may extend through side panel 36 to provide the proper structural rigidity and robustness required to withstand shipping, handling and inspection procedures.

Side panel 36 includes a boss 50 providing support for a package shelf 52. Package shelf 52 is constructed substantially similarly to side panel 36. Specifically, package shelf 52 includes an expanded polypropylene foam core 54 surrounded by a shell 56. Finished external surfaces 58 and 60 are machined to represent the external surface of a production package shelf 52.

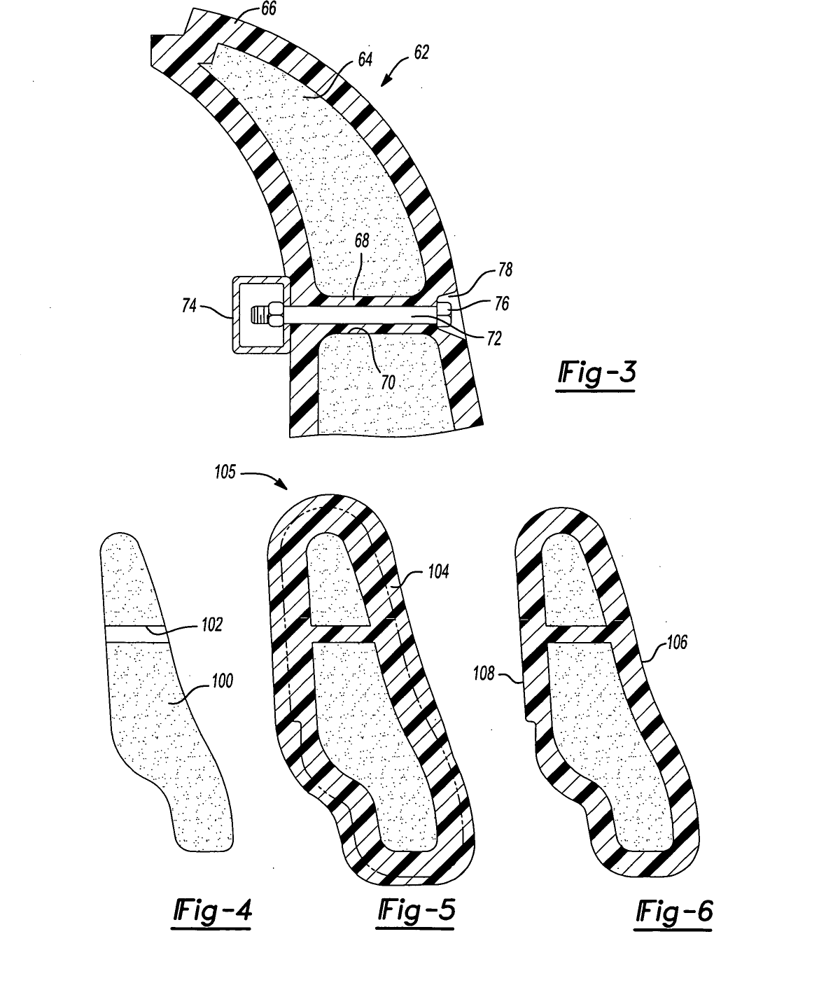

An alternate embodiment side panel 62 is shown in FIG. 3. Side panel 62 includes a core 64 and a shell 66. A column of modeling paste 68 extends through an aperture 70 formed in core 64. A threaded fastener 72 extends through column 68 to couple side panel 62 to a frame member 74. Depending on the size of the verification model to be constructed and the size of panels that are to be supported, additional structural members such as frame member 74 and fastener 72 may be incorporated within design verification model 30. Fastener 72 includes a flanged head 76 positioned within a recess 78 formed within shell 66.

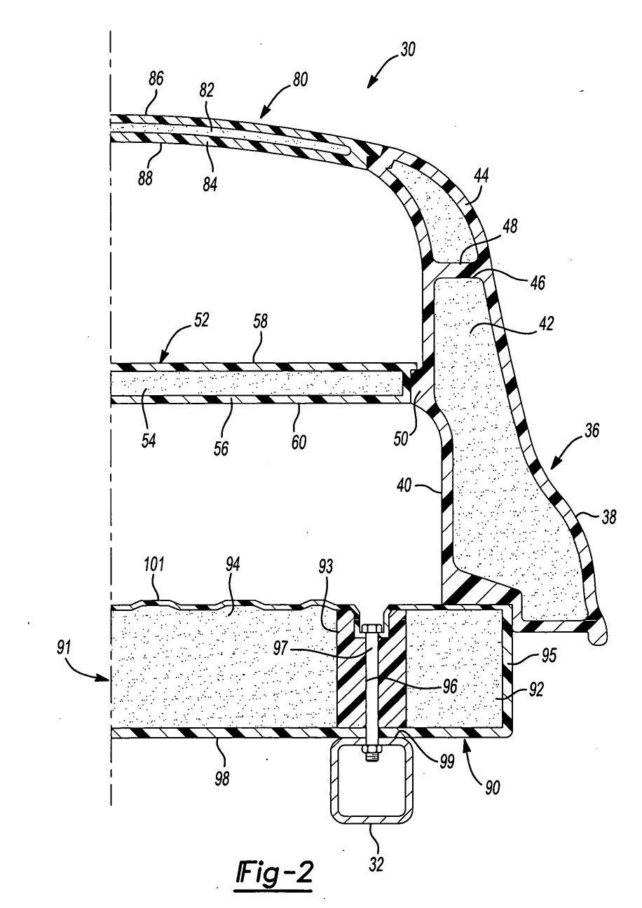

Referring once again to FIG. 2, design verification model 30 includes a roof panel 80 coupled to side panel 36. Roof panel 80 may be interconnected to side panel 36 via any number of methods including a flange joint, a tongue and groove interconnection or mechanical fasteners as desired.

Roof panel 80 includes a core 82. Core 82 is surrounded by a shell of hardened modeling paste 84. An external surface 86 and an internal surface 88 are machined to represent the final model surfaces.

A floor panel 90 includes a core 91 constructed from a first block of expanded polypropylene foam 92, a stringer 93 and a second block of expanded polypropylene foam 94. A shell 95 surrounds core 91.

An aperture 96 extends through stringer 93. A threaded fastener 97 extends through aperture 96. Threaded fastener 97 mounts floor panel 90 to steel armature 32. Expanded polypropylene foam may exhibit a coefficient of linear thermal expansion greater than the modeling paste. Stringer 93 is provided to maintain the dimensional integrity of floor panel 90 over a reasonable range of operating temperatures.

Floor panel 90 includes a lower surface 98 in contact with a datum surface 99 of steel armature 32. Lower surface 98 is a machined surface to accurately mate with datum surface 99. Floor panel 90 also includes an upper surface 101 which has been machined from shell 95 to provide a representation of the finished surface of the vehicle floor panel.

With reference to FIGS. 4-6, a process of constructing one of the design verification model panels will be described. Expanded polypropylene foam is typically purchased in sheet form. A number of expanded polypropylene foam sheets are glued to one another to form a three dimensional block having a rough outline of the panel or structure to be modeled.

FIG. 4 depicts a block of expanded polypropylene foam that has been rough milled to a size less than the size of the finished panel to define a core 100. The electronic data defining the finished external surfaces to be modeled is used to define the cutting path for manufacturing the core. The machined surfaces of the core are substantially the same shape as the finished model but are located at an offset from the finished surfaces to allow for a build-up of modeling paste. An optional aperture 102 extends through rough milled foam core 100 if a column or columns are to be formed in the later steps.

FIG. 5 depicts a shell 104 coupled to rough milled foam core 100 to form a work-in-process assembly 105. Shell 104 may be formed by spraying, rolling, spackling or otherwise applying a pliable modeling paste to core 100. At this stage, shell 104 has a thickness greater than the final thickness of shell 104 shown in FIG. 6. Specifically, it is assured that sufficient stock exists to machine a finished exterior surface 106 and a finished interior surface 108 as shown in FIG. 6 and represented by phantom lines in FIG. 5. By controlling the rough milled size of core 100 and the paste application process to define shell 104, the size of work-in-process assembly 105 may be optimized such that only a minimal amount of shell 104 need be machined to define finished surfaces 106 and 108. Once the finished surfaces have been created, the panels may be mounted to steel armature 32 and one another to define design verification model 30.

As shown in FIG. 2, some or all of the panels may be reinforced as required. One of the methods of strengthening the panels shown includes creating a core having a block of expanded polypropylene foam positioned on either side of a member, such as stringer 93, constructed from a relatively higher strength material. An elongated rib of wren board may serve this purpose. Alternatively, blocks of higher strength material may be inserted within pockets formed within the expanded polypropylene foam core. Fasteners may also extend through the higher strength materials to provide interconnection points for the various panels.

After the model has fulfilled its purpose, the expanded polypropylene foam core is separated from the shell. Heat may be applied to the shell to promote the separation. The expanded polypropylene foam core is recycled and the shell is disposed.

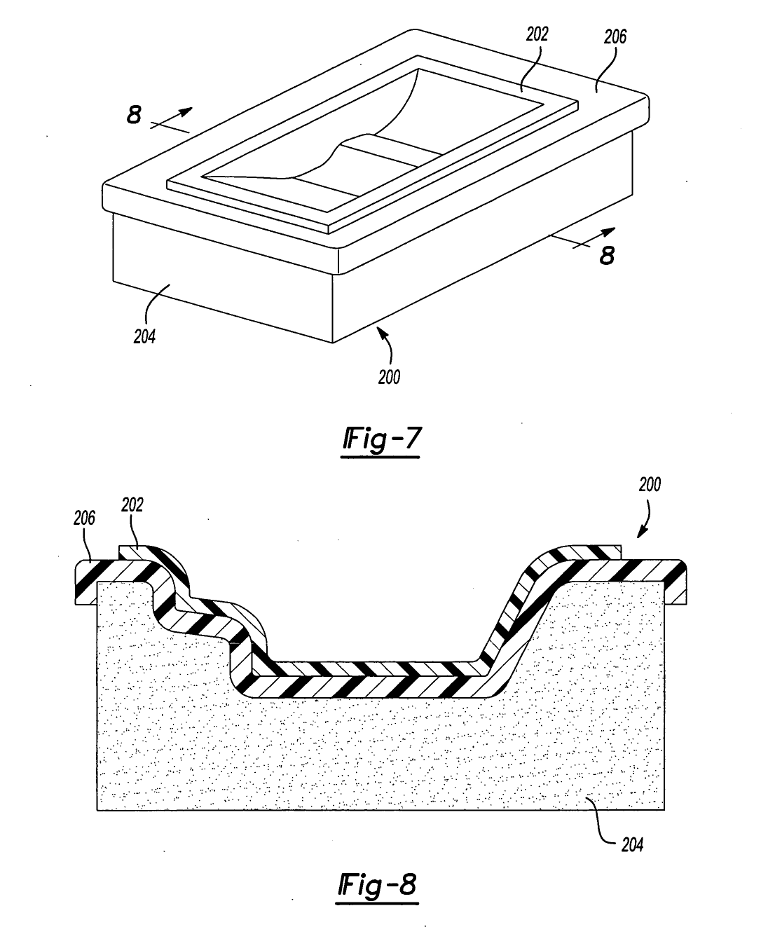

FIGS. 7-11 relate to a mold 200 and a method of constructing mold 200 as a composite three dimensional structure similar to the panels of design verification model 30. FIGS. 7 and 8 depict a mold 200 operable to construct a component 202. Mold 200 includes a body 204 formed from expanded polypropylene foam and a shell 206 bonded to body 204. Shell 206 is constructed from a modeling paste as previously described in relation to design verification model 30.

Mold 200 may be used as a form to create component part 202 via a hand lay-up method. Component part 202 may be constructed from fiberglass mat and resin, carbon fiber, two-part epoxy, SMC and the like.

Alternatively, mold 200 may represent an upper or lower half operable to work in conjunction with another mold half (not shown). Mold 200 and the mold half not shown would define a cavity in which molten resin may be inserted to form an injection molded part.

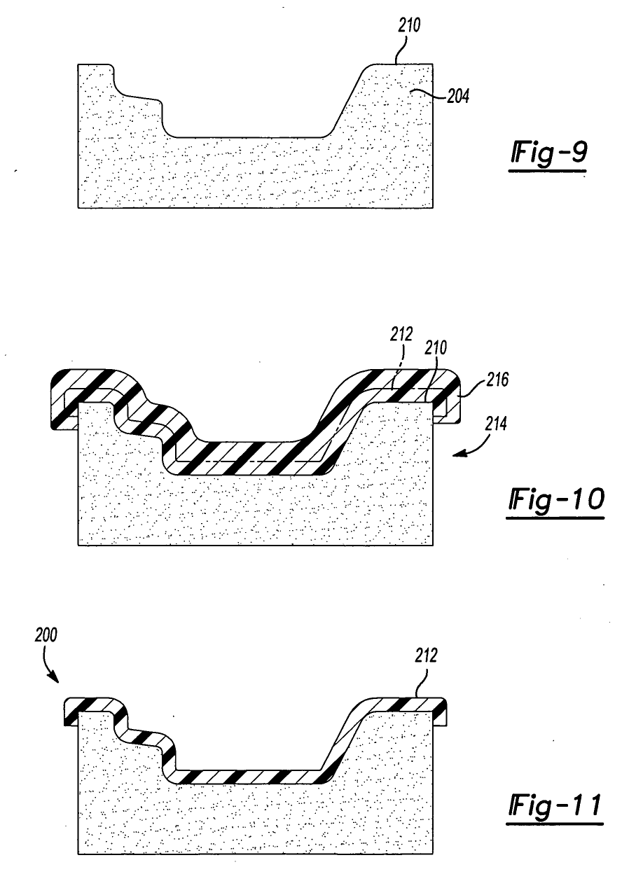

FIGS. 9-11 depict a process for constructing mold 200. A rough-milled body such as body 204 is constructed from a block of expanded polypropylene foam using data from a computer program. Upper surface 210 is machined as a surface offset from and beneath a finished mold surface 212 as shown in FIG. 11.

A work-in-process level mold 214 is depicted in FIG. 10 as including body 204 and a shell 216. Shell 216 is constructed to include a thickness sufficient to provide machining stock to allow a cutter such as an end mill to define finished surface 212 (FIG. 11). Work-in-process mold 214 is then moved to a machine where finished surface 212 is machined.

Depending on the type of material used to form component 202, a release agent may be applied to surface 212 prior to the hand lay-up or injection molding procedure to allow the component 202 to be removed from mold 200 without damaging the mold. Accordingly, it is contemplated that mold 200 may be repeatedly used to construct a number of substantially similar components 202.

Through the use of expanded polypropylene foam and a relatively thin shell of modeling paste, mold 200 may be constructed as a lightweight, low cost tool. As mentioned in relation to design verification model 30, mold 200 may be easily modified and/or repaired by simply adding or removing additional modeling paste and machining the appropriate section of mold 200 to define the revised mold surface.

Modeling paste is sufficiently dense to allow finished machining and provide an aesthetically pleasing surface finish. Additionally, the modeling paste is not as dense and machines much more easily than prior art molds constructed from two-part epoxy, kirksite or steel. Therefore, the time required to machine finished surface 212 is substantially less than the time required to machine the previously listed materials.

Furthermore, the foregoing discussion discloses and describes merely exemplary embodiments of the present invention. One skilled in the art will readily recognize from such discussion, and from the accompanying drawings and claims, that various changes, modifications and variations may be made therein without department from the spirit and scope of the invention as defined in the following claims.

What is claimed is:

1. A method of making a three dimensional object, comprising:
obtaining electronic data defining a first finished surface of the three dimensional object;
shaping a block of expanded polypropylene foam based on the electronic data, wherein at least one surface of the expanded polypropylene foam block is offset from the first finished surface of the three dimensional object;
applying a layer of hardenable paste to the offset surface of the block of expanded polypropylene foam;
hardening the paste; and
machining the paste to form the first finished surface of the three dimensional object.

2. The method of claim 1 further including obtaining data defining a second finished surface of the three dimensional object, shaping the block of expanded polypropylene foam to include a surface offset from the second finished surface, applying a layer of hardenable paste to the surface of the foam block offset from the second finished surface, hardening the paste and machining the paste to form the second finished surface of the three dimensional object.

3. The method of claim 2 wherein the first and second finished surfaces are substantially parallel to one another and positioned on opposite sides of the block.

4. The method of claim 3 wherein the first finished surface corresponds to an external surface of a vehicle and the second finished surface corresponds to an interior surface of a vehicle.

5. The method of claim 1 further including machining another block of expanded polypropylene foam, coating the another block with hardenable paste, machining the paste and engaging machined surfaces of the hardened paste bonded to the block and the another block with one another.

6. The method of claim 5 further including mounting at least one of the plurality of panels to a datum surface of an armature.

7. The method of claim 1 further including forming an aperture to extend through the expanded polypropylene block and filling the aperture with the hardenable paste.

8. The method of claim 7 further including hardening the paste within the aperture to form a column, defining an aperture extending through the column and positioning a fastener within the aperture extending through the column to couple the three dimensional object to another object.

9. The method of claim 1 further including encapsulating the block of expanded polypropylene foam within the hardenable paste and machining a majority of the exterior surfaces of the hardened paste.

10. The method of claim 1 wherein the three dimensional object is a reusable mold, the method further including placing a hardenable material on a surface of the mold, hardening the material to form a component and removing the component from the mold without destroying the mold.

11. The method of claim 1 further including forming the block from recyclable material.

12. A three dimensional structure having finished surfaces defined by electronic data, the three dimensional structure comprising:
a core of expanded polypropylene foam having at least one surface offset from one of the finished surfaces of the three dimensional structure; and
a layer of hardened paste bonded to the offset surface of the core of expanded polypropylene foam, wherein the hardened paste is machined to define the finished surfaces of the structure.

13. The three dimensional structure of claim 12 further including a column of hardened paste extending through the core.

14. The three dimensional structure of claim 13 further including a fastener extending through the column to couple the three dimensional structure including the column to a component.

15. The three dimensional structure of claim 14 wherein the core is encapsulated by the hardened paste.

16. The three dimensional structure of claim 12 wherein the core includes multiple blocks of expanded polypropylene foam coupled to one another.

17. The three dimensional structure of claim 16 wherein the core includes a stringer of relatively high strength material positioned between two blocks of expanded polypropylene foam.

18. The three dimensional structure of claim 17 wherein a fastener extends through the stringer to couple the structure to a component.

19. The three dimensional structure of claim 12 further including an armature having a datum plane, one of the finished surfaces being mounted to the datum plane.

20. The three dimensional structure of claim 19 further including an additional core having a layer of machined hardened paste bonded to the additional core, the additional core being coupled to the armature.

21. The three dimensional structure of claim 20 wherein the hardened paste machined surfaces of the core and the additional core are positioned in engagement with one another.

22. The three dimensional structure of claim 12 wherein the finished surface defines a mold cavity.

23. The three dimensional structure of claim 12 wherein the core is constructed from a recyclable material.
